(19) United States
(12) Patent Application Publication
(10) Pub. No.: US 2005/0040647 A1
(43) Pub. Date: Feb. 24, 2005

(54) Connector

(76) Inventor: Craig Dean Campbell, Atlanta, GA (US)

Correspondence Address: Craig Dean Campbell, 1856 Colt Drive, Atlanta, GA, 30341, US

(21) Appl. No.: 10/876,098

(22) Filed: Aug. 29, 2002

(51) Int. Cl. F16L 27/00

(52) U.S. Cl. 285/272

(57) ABSTRACT

A semi-flexible U shaped tube with a rotate to lock female water hose thread fitting on one end and a stationary female pipe thread fitting on the other end. This device allows a sprinkler head and a water-timing device to be attached to a pre-existing spigot as a compact one-unit structure. The semi-flexible tubing of the connector allows adjustments to the water-throw of the sprinkler.

### BACKGROUND OF THE INVENTION

The invention relates to spigots, watering timers, sprinkler heads and/or extension pipes used to supply water to grasses, shrubs, flowers, trees and other items that need water. The connector is attached at the water supply spigot with use of a female water hose thread spin lock fitting. This fitting is attached to a semi-flexible tube, which is connected to a female pipe thread fitting in a vertical position. The vertical portion projects away from the spigot for connection of the watering timer, sprinkler, extension pipe, and/or other watering devices.

Such connectors are often used in today's watering systems and are known in practice. In the case of the known connectors, a watering timer with a female water hose fitting is connected to a spigot. The other side of the water timer has a male water hose connection and is connected to a garden hose. The other end of the garden hose is connected to a ground mounted sprinkler head. The disadvantage of the known connector is that the garden hoses and ground mounted sprinkler heads are tripping hazards, which can result injury as well as accidental movement of the sprinkler out of the correct positioning.

### SUMMARY OF THE INVENTION

It is accordingly an object of the invention to provide a connection which overcomes the herein aforementioned disadvantages of the heretofore-known devices of this general type in such a way that it allows a watering sprinkler or other water delivery device, either with optional watering timer device, to be attached to a pre-exiting spigot in an easy to install, compact, one piece, semi-permanent manner without using hoses or ground mounted sprinkler heads.

With the foregoing and other objects in view there is provided, in accordance with the invention, a connector for a water spigot leading to a water delivery system such as a water timer attached to a sprinkler head. The connector is attached to a water supplying spigot and the connector comprises of a semi-flexible tube and a connection female pipe thread having a vertical portion projecting away from the spigot for connection to a water delivery system.

As a results of this configuration, on one hand, garden hoses and ground-mounted sprinklers are not used thus eliminating the unsightly appearance of such items.

In accordance with another feature of the invention, garden hoses and ground-mounted sprinklers are not used resulting in eliminating tripping hazards over such items.

In accordance with a further feature of the invention, ground mounted sprinklers are not used thus eliminating the potential of being struck by vehicles and/or pedestrians which would result in altering the correct positioning of the sprinkler's intended delivery target.

In accordance with an added feature of the invention, the connector can be assembled to the timer and sprinkler in a convenient location prior to attachment to the water spigot.

In accordance with an additional feature of the invention, the connector when used with a timer and/or sprinkler head makes a compact water delivery system relative other systems.

In accordance with yet another feature of the invention, the connector when used with a timer and/or sprinkler head, fits close to the surface of the wall housing the water spigot thus reducing accidental strikes by vehicles and pedestrians thus reducing trip hazards and alteration of the correct positioning of the sprinkler's intended delivery target.

In accordance with yet another feature of the invention, the connector tube is semi-flexible thus allowing it to be bent as needed to fine-tune the aim of the sprinkler's water throw pattern.

In accordance with a concomitant feature of the invention, the connector allows parts of the system to be above ground level thus reducing moister from the ground corroding the connector and its attachments.

Although the invention is illustrated and described herein as embodied in a connection, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic view of a water flow timer, a sprinkler head, a water spigot and the connector according to the invention;

FIG. 2 is a fragmentary side view of the connector;

FIG. 3 is a fragmentary end view of the connector;

FIG. 4 is a fragmentary, sectional view of the connector, which is taken along a line II-II of FIG. 3 in the direction of the arrows.

### DESCRIPTION OF THE EMBODIMENTS

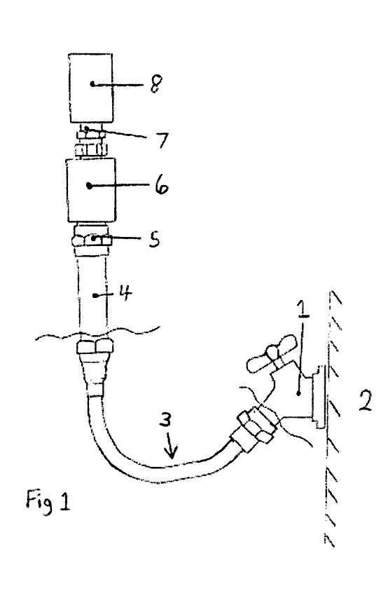

Referring now to the figures of the drawings in detail and first, particularly, to FIG. 1 thereof, there is seen a water spigot 1 which is provided for use in a water supply system for a wall 2 of a non-illustrated building. The spigot I has a connector 3 with a riser male pipe-threaded pipe 4 connected thereto. The riser male pipe-threaded pipe 4 is connected to the female pipe-threaded side of fitting 5. The female water-pipe-thread side of fitting 5 is connected to the male water-pipe-threaded side of a watering timer 6. The female water-pipe-threaded side of a watering timer 6 is connected to the male water-pipe-thread side of fitting 7. The male pipe-threaded side of fitting 7 is connected to a sprinkler head 8.

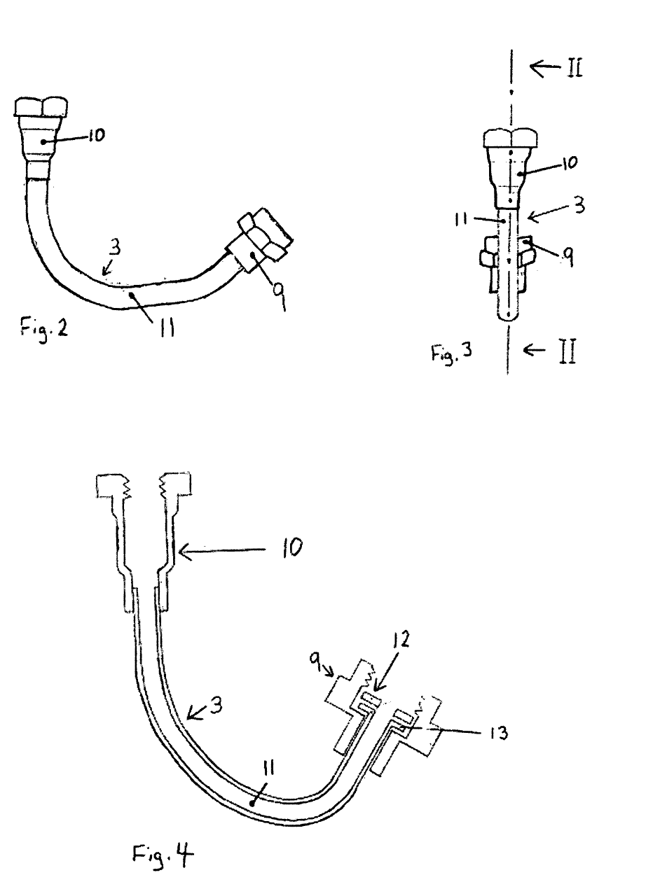

FIG. 2 is an enlarge side view of the connector 3 when it is disconnected from the spigot 1 and the riser male pipe-threaded pipe 4 to simplify the drawing. The semi-flexible tubing 11 has a rigidity level, which allows it to maintain its shape when the force from the FIG. 1 sprinkler head 8 is operational under water pressure.

FIG. 3 is an end view of connector 3.

FIG. 4 is a sectional view through the connector 3, which is taken along a line II-II in FIG. 3. The sealing gasket 12 is placed against the seating flange 13, which is part of the semi-flexible tubing 11. The semi-flexible tubing 11 is threaded through the female water hose fitting 9 and is free to spin until the female water hose fitting 9 is properly torqued onto the water spigot 1 in FIG. 1, which produces a water seal between the sealing gasket 12, seating flange 13 and the female water hose fitting 9. The semi-flexible tubing 11 is then connected to the female pipe thread fitting 10.

2. A connector for a sprinkler-timer system for delivering water, the connector disposed at a water spigot and the connector comprised of:
a. Female water-pipe thread fitting, which swivels around the semi-flexible tubing until torqued to the spigot; and
b. A semi-flexible tubing which will retain its shape under the force generated when the sprinkler head is operational but can be bent to adjust the water throw of the sprinkler head; and
c. A female pipe thread fitting connected to the semi-flexible tubing.
A connector for a sprinkler-timer system for delivering water, the connector disposed at a water spigot and the connector comprised of:
a. Female water-pipe thread fitting, which swivels around the semi-flexible tubing until torqued to the spigot; and
b. A semi-flexible tubing which will retain its shape under the force generated when the sprinkler head is operational but can be bent to adjust the water throw of the sprinkler head; and
c. A female pipe thread fitting connected to the semi-flexible tubing.
